(19) United States
(12) Patent Application Publication
(10) Pub. No.: US 2002/0103652 A1
(43) Pub. Date: Aug. 1, 2002

(54) Decoding device, decoding method and automobile audio system with such a decoding device

(75) Inventors: Andreas Stiegler, Ettlingen (DE); Harald Schopp, Ettlingen (DE); Michael Zeller, Karlsbad (DE)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Harman Becker Automotive Systems GmbH

(21) Appl. No.: 09/994,471

(22) Filed: Nov. 26, 2001

(30) Foreign Application Priority Data
Jan. 24, 2001 (DE) 101 03 134.3

(51) Int. Cl. G10L 21/04

(52) U.S. Cl. 704/503

(57) ABSTRACT

An audio decoding device for decompressing an audio signal that was compressed in accordance with a given compression method having a program-controlled signal processor which receives the compressed audio signal and from it produces a decompressed audio signal under the control of a decompression program; a loadable program memory that is connected to the signal processor for storing the decompression program; and a management device which is connected to the program memory and is controlled by the compressed audio signal, and which manages decompression programs corresponding to at least two different compression methods in order to determine the respectively used compression method from the compressed audio signal, to select the pertinent decompression program and to load the pertinent decompression program into the program memory.

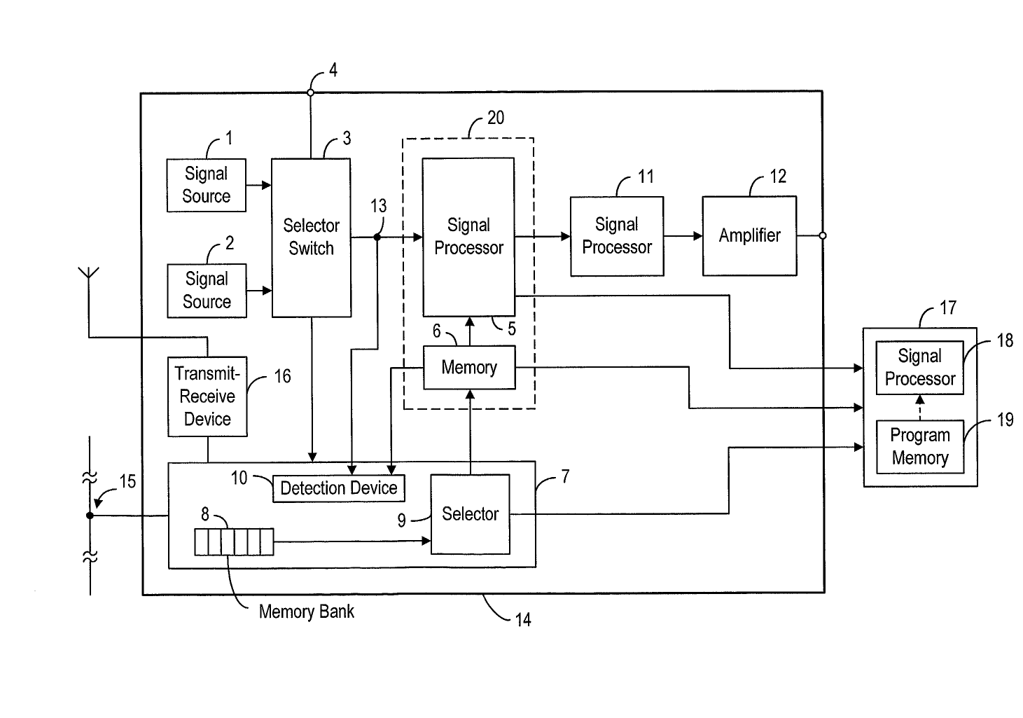

### TECHNICAL FIELD

The invention concerns a decoding device and a decoding method for decompressing an audio signal which was compressed in accordance with a given compression method and an automobile audio system with such an audio decoding device.

### BACKGROUND OF THE INVENTION

In the meantime compressed data formats also find increasing use in automobiles. The reason is the increase of multimedia functions with a principle-conditioned lack of transmission bandwidth and/or storage bandwidth for the applicable data. Most of the compression methods being used originate from the home computer or the consumer product world, both of which are known for a quick technological change. This means that these compression methods quickly disappear from the market to make room for new methods.

By contrast, applications in automobiles depend on long development lead times and significantly longer product cycles. It must therefore be considered that the compression/decompression methods anticipated at the start of a development are no longer current when the product is introduced, and other compression/decompression methods are used. The methods used to decompress such data formats especially in automobile audio systems utilize a determined solution for every individual compression method. Due to the long development lead time and a long running time, the corresponding instruments in the automobile therefore age relatively quickly.

U.S. Pat. No. 6,122,619 describes an audio decoding device for two different compression or decompression methods, but this patent is essentially a combination of two individual solutions and does not significantly increase the flexibility of the total system.

### SUMMARY OF THE INVENTION

It is therefore the object of the invention to present a decoding device, a decoding method and an automobile audio system with an audio installation that does not contain these drawbacks.

The object is achieved by a decoding device for decompressing an audio and/or video signal that was compressed in accordance with a given compression method, comprising a program-controlled signal processor which receives the compressed audio or video signal and produces a decompressed audio or video signal under the control of a decompression program; a loadable program memory which is connected to the signal processor, for storing the decompression program; and a management device which is connected to the program memory and is controlled by the compressed audio or video signal; wherein the management device manages decompression programs which correspond to at least two different compression methods in order to determine the respectively used compression method from the compressed audio signal, to select the pertinent decompression program and to load the decompression program into the program memory, wherein the management device includes an access device via which new decompression programs can be entered into the management device, and/or old decompression programs can be deleted.

Another object of the present invention is an automobile audio system with at least one signal source which produces compressed audio signals, a downstream signal processor and an audio decoding device to decompress an audio signal that was compressed in accordance with a given compression method, comprising a program-controlled signal processor, which receives the compressed audio signal and from it produces a decompressed audio signal under control of a decompression program; a loadable program memory which is connected to the signal processor for storing the decompression program; and a management device which is connected to the program memory and is controlled by the compressed audio signal, and manages decompression programs corresponding to at least two different compression methods, in order to determine the respectively used compression method from the compressed audio signal, to select the pertinent decompression program and to load the decompression program into the program memory.

A further object of the invention is a decoding method for decompressing an audio and/or video signal that was compressed in accordance with a given compression method, by means of a signal processor and a program memory connected thereto; wherein the respectively used compression method is determined from the compressed audio or video signal, the pertinent decompression program is selected and loaded into the program memory; and wherein a decompressed audio or video signal is produced from the compressed audio or video signal under the control of the decompression program stored in the program memory.

The advantage of the invention is that maximum flexibility is obtained with a small effort and using conventional, for example generally available components.

This is achieved in particular by a decoding device with a program-controlled signal processor, which receives the compressed audio and/or video signal and produces a decompressed audio or video signal under the control of a decompression program, and with a loadable program memory that is connected to the signal processor and stores the decompression program. In addition a management device is provided, which is connected to the program memory and is controlled by the compressed audio or video signal. The management device manages at least two decompression programs which correspond to two different compression methods, in order to determine the respectively used compression method from the compressed audio or video signal, select the pertinent decompression program and load it into the program memory. To that end the management device includes an access device which it uses to enter new and/or delete old decompression programs in the management device. The access devices are preferably interfaces (for example Media Oriented System Transport “MOST”) or signal sources which e.g. also produce or play back the audio or video signals (for example input via compact disc or digital video disc).

In a further development of the invention, the signal processor and the program memory are located in a signal processing installation, where the management device can load a decompression program into the program memory via an interface. The signal processing installation can be commercial or specially designed signal processors in which the signal processor (e.g. processor core) and the program memory are preferably integrated into a chip. The signal processor can be designed for decompression alone, or it can also take on additional tasks. The interface can be designed especially for that purpose, or it can be a standardized interface (e.g. a conventional I/O interface).

The management device preferably contains information about which decompression program is stored in the program memory. Only if the stored decompression program and the decompression program to be loaded differ will the management device load the decompression program to be loaded into the program memory. The information about which decompression program is stored in the program memory can either be produced by the management device itself (for example by storing information about the last loaded decompression program in the program memory), or it can obtain corresponding information from the program memory and/or the signal processor. This prevents the unnecessary loading of a decompression program which already exists in the program memory.

The management device preferably contains another interface via which new decompression programs can be entered and/or old decompression programs can be deleted in the management device. For example the data bank containing the decompression method can be updated each time the vehicle goes to the shop. In this way for example an automobile audio system is always kept at the state of the art without the need for hardware changes.

Furthermore at least the signal processor and the program memory can be integrated into a network, into which other signal processors and other program memories can also be integrated. In that case a central processor unit can both be a fully independent component of the network, and an integrated part of an overriding component. It is furthermore possible to install several central processor units. This can take place inside a single component as well as with an architecture that is distributed over several components. The network can be a local network operating in a self-sufficient manner, or it can be connected to a global network (e.g. the internet).

A decoding device in accordance with the invention and the above claims is preferably used for an automobile audio system. The advantage with the present invention is that the usually long lead times, the long service life and the fact that audio components in automobiles are more difficult to replace than for example in a home audio system, do not lead to the premature aging of the audio components, and the most recent compression or decompression methods can still be applied.

The decoding method of the invention for decompressing an audio and/or video signal compressed in accordance with a given compression method by means of a signal processor and a program memory connected thereto, allows the determination of the respectively used compression method from the compressed audio or video signal, and thereby to select the pertinent decompression program and load it into the program memory. A decompressed audio or video signal is then produced from the compressed audio or video signal under the control of the thus entered decompression signal in the program memory. Such a method is particularly suitable for use in signal processors.

In a further development of the inventive method, the already stored decompression program is determined, it is compared to a decompression program to be loaded and if there is a difference between the stored program and the decompression program to be loaded, the latter is stored in the program memory. Such a comparison simply entails for example comparing the program labels with each other. If there is a difference, the corresponding new program is loaded and activated.

### BRIEF DESCRIPTION OF THE DRAWING

The invention is explained in greater detail in the following by the embodiment illustrated in the single FIGURE, which is a block diagram of the invention.

### BEST MODE FOR CARRYING OUT THE INVENTION

The illustrated embodiment comprises two signal sources 1, 2, which are for example a CD play-back device, a radio receiver, an MP3 player or some other device. The signal sources 1, 2 in this embodiment are characterized in that they process and/or produce compressed signals in different ways. A selector switch 3 follows the two signal sources 1, 2 and, as a function of an external control signal 4, sends one of the two signal sources 1, 2 to a signal processor 5. The signal processor 5 is one which is program-controlled for example, and its program is stored in a program memory 6 that is connected to the signal processor 5. However the program memory 6 could also be integrated in the signal processor 5 resulting in a signal processor 20. The signal processor 5, in conjunction with the decoding program stored in the program memory 6 is used to decompress digital audio data signals which are provided by the signal source 1 or 2.

A management device 7 loads the decoding program into the program memory 6 and to that end has a program memory bank 8 with a selector 9 installed downstream. As a function of a control signal, the selector 9 selects a decoding program from the program memory bank 8 and loads it into the program memory 6. The control signal for the selector 9 is provided by a detection device 10 which examines the signal supplied to the signal processor 5 to determine which compression method was used. The detection device 10 furthermore determines which decompression program is stored in the program memory 6, and compares the two data with each other. The management device remains inactive if the compression method and the decompression method agree, but if they differ the corresponding decompression program is selected from the program memory bank 8 and loaded into the program memory 6.

In addition a signal processor 11 and an audio amplifier 12 are connected downstream of the signal processor 5. The signal processor 11 provides for example a sound control, a volume control and other sound signal processors. The thus changed signal then undergoes for example a digital-analog conversion and is subsequently amplified by the audio amplifier 12, for example to produce a low frequency audio signal 13 for controlling loudspeakers.

In the illustrated embodiment, the signal sources 1, 2, the selector switch 3, the signal processor 5, the program memory 6, the management device 7, the signal processor 11 and the audio amplifier 12 are components of an automobile audio system 14.

This automobile audio system 14 may be self-sufficient, or it can be connected to a data network if needed, or it can for example be permanently and wirelessly connected to a data network. Thus during a shop visit for example, new decoding programs can be loaded into the automobile audio system via a mechanical connectable, wired interface 15. However, as an alternative a transmit-receive part 16 can also be provided for the wireless data network connection (for example the internet). Furthermore a new decoding program can be loaded via a corresponding data carrier (for example compact disc, digital video disc, etc.) through the signal source 1 or 2 (a corresponding play-back device) and the selector switch 13 (source selection).

As shown in the embodiment, in a further development of the invention the management device 7 can control at least one other unit 17, comprising at least a signal processor 18 and a program memory 19, so that the latter always contains the same decompression program as the program memory 6. In that case for example the two signal processors 5, 18 and the program memories 6, 19 can communicate with each other.

Although only decompression arrangements and methods are shown in the embodiments, which corresponds to the predominant number of applications, the arrangements and methods of the invention can also be applied to compression. Although the decompression concept is therefore only used by itself, it always includes the compression as well.

Having described the invention, what is claimed is:

1. A decoding device for decompressing an audio and/or video signal that was compressed in accordance with a given compression method, comprising:
a program-controlled signal processor (5) which receives the compressed audio or video signal and produces a decompressed audio or video signal under the control of a decompression program;
a loadable program memory (6) which is connected to the signal processor (5), for storing the decompression program; and
a management device (7) which is connected to the program memory (6) and is controlled by the compressed audio or video signal; wherein the management device (7) manages decompression programs which correspond to at least two different compression methods in order to determine the respectively used compression method from the compressed audio signal, to select the pertinent decompression program and to load the decompression program into the program memory (6), wherein
the management device (7) includes an access device (15, 16) via which new decompression programs can be entered into the management device (7), and/or old decompression programs can be deleted.

2. A decoding device as claimed in claim 1, in which the signal processor (5) and the program memory (6) are located in a signal processor (20), and wherein the management device (7) can load a decompression program into the program memory (6).

3. A decoding device as claimed in claim 2, wherein the management device (7) has information about which decompression program is stored in the program memory (6), and only loads the decompression program to be loaded into the program memory (6) if there is a difference between the stored decompression program and the decompression program to be loaded.

4. A decoding device as claimed in claim 3, wherein at least the signal processor (5) and the program memory (6) are integrated into a network.

5. A decoding device as claimed in claim 4, wherein other signal processors (20) and other program memories (19) are integrated into the network.

6. A decoding device as claimed in claim 5, wherein the access device is an interface (15, 16).

7. A decoding device as claimed in claim 6, wherein the access device is a signal source that is also suitable for producing audio or video signals.

8. A decoding device as claimed in claim 1, wherein the management device (7) has information about which decompression program is stored in the program memory (6), and only loads the decompression program to be loaded into the program memory (6) if there is a difference between the stored decompression program and the decompression program to be loaded.

9. A decoding device as claimed in claim 1, wherein at least the signal processor (5) and the program memory (6) are integrated into a network.

10. A decoding device as claimed in claim 9, wherein other signal processors (20) and other program memories (19) are integrated into the network.

11. A decoding device as claimed in claim 1, wherein the access device is an interface (15, 16).

12. A decoding device as claimed in claim 1, wherein the access device is a signal source that is also suitable for producing audio or video signals.

13. An automobile audio system with at least one signal source (1, 2) which produces compressed audio signals, a downstream signal processor (11, 12) and an audio decoding device (5) to decompress an audio signal that was compressed in accordance with a given compression method, comprising:
a program-controlled signal processor (5), which receives the compressed audio signal and from it produces a decompressed audio signal under control of a decompression program;
a loadable program memory (6) which is connected to the signal processor (5) for storing the decompression program; and
a management device (7) which is connected to the program memory (6) and is controlled by the compressed audio signal, and manages decompression programs corresponding to at least two different compression methods, in order to determine the respectively used compression method from the compressed audio signal, to select the pertinent decompression program and to load the decompression program into the program memory.

14. A decoding method for decompressing an audio and/or video signal that was compressed in accordance with a given compression method, by means of a signal processor (5) and a program memory (6) connected thereto,
wherein the respectively used compression method is determined from the compressed audio or video signal, the pertinent decompression program is selected and loaded into the program memory (6); and
wherein a decompressed audio or video signal is produced from the compressed audio or video signal under the control of the decompression program stored in the program memory (6).

15. A decoding method as claimed in claim 14, wherein the decompression program already stored in the program memory (6) is determined, it is then compared with a decompression program to be loaded, and if there is a difference between the stored program and the decompression program to be loaded, the latter decompression program is loaded into the program memory (6).
